(19) United States
(12) Patent Application Publication
(10) Pub. No.: US 2017/0370423 A1
(43) Pub. Date: Dec. 28, 2017

(54) CLUTCH PLATE HAVING DISCONTINUOUS FRICTION MATERIAL PATTERN

(71) Applicant: GM Global Technology Operations LLC, Detroit, MI (US)

(72) Inventors: Jose R. Morales, Pontiac, MI (US); Gregory W. Deneszczuk, Royal Oak, MI (US)

(21) Appl. No.: 15/190,959

(22) Filed: Jun. 23, 2016

(51) Int. Cl. F16D 13/64; F16D 69/00

(52) U.S. Cl. CPC F16D 13/648; F16D 69/00

(57) ABSTRACT

The invention comprehends friction plates, typically fabricated of metal, having friction material that is disposed in multiple concentric bands disposed in interrupted or discontinuous segments or a combination of both. In a first embodiment, the friction material is arranged in two concentric bands on each face, an inner band having a smaller radial width and an outer band having a larger radial width. In a second embodiment, the inner band is replaced with a plurality of discontinuous sections or segments wherein their circumferential separation is greater than their circumferential length. A third embodiment is similar to the second embodiment except that the inner, discontinuous segments have a circumferential length greater than their circumferential separation.

### FIELD

The present disclosure relates to friction plates for clutches and more particularly to friction plates for friction clutches having interrupted or discontinuous patterns of friction material on the faces of the clutch plates.

### BACKGROUND

The statements in this section merely provide background information related to the present disclosure and may or may not constitute prior art.

Friction clutch assemblies are extraordinarily common components of mechanical power transmission devices. Wherever a rotating, torque supplying member must be coupled to an initially non-rotating member a friction clutch will generally be utilized. The friction clutch typically includes one or more plates rotationally coupled to a first member having friction material on both faces which are interleaved with plates such as reaction plates which are rotationally coupled to a second member and which lack such material. The interleaved plates are compressed by a linear actuator and, when compressed, torque is transmitted through the device.

In the prior art, the friction material on the clutch plates takes the form of two bands of equal inside and outside diameters that are secured to opposite faces of the clutch plate, typically by an adhesive. The bands may be fabricated of clutch paper or of a more specialized material that provides certain, desirable frictional characteristics. While simple and inexpensive, this friction material configuration is accompanied by certain shortcomings. First of all, a continuous band of material may interfere with radial flow of cooling and lubricating fluid in a wet clutch. Second of all, because the outside edge of the band of friction material is generally adjacent to the outside edge of the clutch plate, uneven pressure and loading on the plates of the clutch may result. Such uneven loading can result in both reduced torque capacity and service life.

The present invention is directed to improving torque capacity and service life by addressing this problem.

### SUMMARY

The present invention provides a friction plate having interrupted or discontinuous bands of friction material on its faces. The invention comprehends friction plates, typically fabricated of metal, having friction material that is disposed in concentric bands disposed in interrupted or discontinuous segments or a combination of both. In a first embodiment, the friction material is arranged in two concentric bands on each face, an inner band having a smaller radial width radially spaced from an outer band having a larger radial width. In a second embodiment, the inner band is replaced with a plurality of discontinuous sections or segments wherein their circumferential separation is greater than their circumferential length. A third embodiment is similar to the second embodiment except that the inner, discontinuous segments have a circumferential length greater than their circumferential separation. Friction plates having either inner, female splines or outer, male splines as well as a friction clutch assembly incorporating friction plates incorporating the present invention are also disclosed. Friction plates embodying the present invention provide improved lubrication circulation in wet clutches and thus improved heat dissipation as well as enhanced operation.

Thus it is an aspect of the present invention to provide a friction plate having interrupted or non-continuous bands of friction material on its faces.

It is a further aspect of the present invention to provide a friction plate having multiple, radially spaced apart bands of friction material on its faces.

It is a still further aspect of the present invention to provide a friction plate having circumferentially interrupted or spaced apart segments or section of friction material on its faces.

It is a still further aspect of the present invention to provide a friction plate having a combination of multiple spaced apart bands and discontinuous segments of friction material on its faces.

It is a still further aspect of the present invention to provide a friction clutch assembly incorporating friction plates having interrupted or non-continuous bands of friction material on their faces.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a plan view of a first embodiment of a clutch plate for a friction clutch assembly having two radially spaced apart and continuous bands or annuli of friction material;

FIG. 2 is a fragmentary, sectional view of the first embodiment of a clutch plate for a friction clutch assembly taken along line 2-2 of FIG. 1;

FIG. 3 is a plan view of a second embodiment of a clutch plate for a friction clutch assembly having an outer continuous band or annulus of friction material and an inner discontinuous or segmented band or annulus of friction material with smaller segments and larger spaces;

FIG. 4 is a fragmentary, sectional view of the second embodiment of a clutch plate for a friction clutch assembly taken along line 4-4 of FIG. 3;

FIG. 5 is a plan view of a third embodiment of a clutch plate for a friction clutch assembly having an outer continuous band or annulus of friction material and an inner discontinuous or segmented band or annulus of friction material with larger segments and smaller spaces;

FIG. 6 is a fragmentary, sectional view of the third embodiment of a clutch plate for a friction clutch assembly taken along line 6-6 of FIG. 5; and

FIG. 7 is a full, sectional view of a friction clutch pack assembly having friction clutch plates incorporating to the present invention.

### DETAILED DESCRIPTION

The following description is merely exemplary in nature and is not intended to limit the present disclosure, application, or uses.

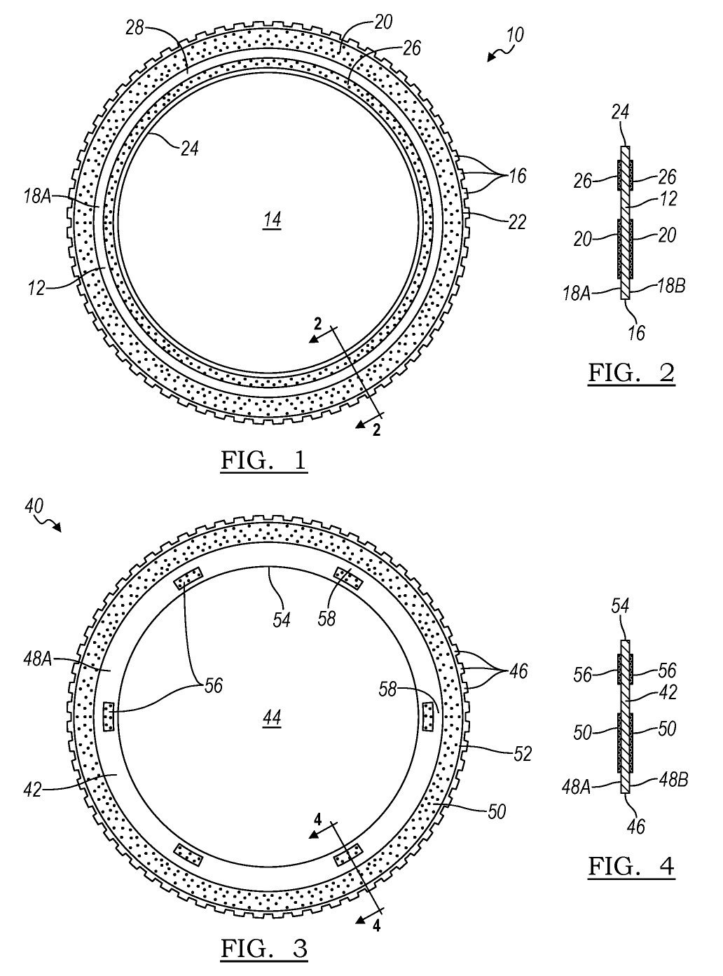

With reference to FIGS. 1 and 2, a first embodiment of a friction clutch plate incorporating the present invention is illustrated and generally designated by the reference number 10. The friction clutch plate 10 includes a flat metal disc or plate 12 which defines a large center opening 14 and a plurality of male splines or teeth 16 disposed and evenly circumferentially spaced about its periphery. The plurality of male splines or teeth 16 engage and drive (or are driven by) complementarily configured female spines or teeth in a clutch housing described below with reference to FIG. 7. The friction clutch plate also defines flat or planar opposed front and back sides, faces or surfaces 18A and 18B.

An identical pattern or arrangement of friction material is disposed on both front and back surfaces 18A and 18B and thus only the complete front surface 18A is illustrated and will be described, it being understood that the back side, surface or face 18B is identical to the front side, surface or face 18A. On the front face 18A of the friction plate 10 resides a continuous first or outer band or annulus of friction material 20 having an outer circumferential edge 22 disposed just radially inside and adjacent the minor diameter of the splines or teeth 16 on the periphery of the friction plate 10. Similarly, just inside and adjacent the inner edge 24 of the friction plate 10 resides a continuous second or inner band or annulus of friction material 26. The friction material utilized here and in the other disclosed embodiments may be either what is commonly referred to as friction paper or may be one of numerous other conventional or proprietary materials commonly utilized in friction clutch assemblies which is secured to the front and back surfaces 18A and 18B of the disc or plate 12 by an adhesive.

The width of the first band or annulus of friction material 20 is preferably approximately twice as wide as the width of the second band or annulus of friction material 26. A circular space or region 28 radially separates the inner and outer bands 20 and 26 of friction material. Preferably, the width of the circular space or region 28 between the bands 20 and 26 of friction material is approximately as wide as the width of the second, inner band 26 of friction material. As noted above, the inner and outer diameters of the bands 20 and 26 are the same width and spacing on each face 18A and 18B so that axial forces applied to the friction material 20 and 26 do not distort, i.e., warp, the friction plate 10.

Referring now to FIGS. 3 and 4, a second embodiment of a friction clutch plate incorporating the present invention is illustrated and generally designated by the reference number 40. Once again, the second embodiment friction clutch plate 40 includes a flat or planar metal disc 42 which defines a large center opening 44 and a plurality of male splines or teeth 46 disposed and evenly circumferentially spaced about its periphery. The plurality of male splines or teeth 46 engage and drive (or are driven by) complementarily configured female spines or teeth in a clutch housing described below with reference to FIG. 7. The friction clutch plate also defines planar opposed front and back sides, faces or surfaces 48A and 48B.

An identical pattern or arrangement of friction material is disposed on both front and back surfaces 48A and 48B and thus only the complete front surface 48A is illustrated and will be described, it being understood that the back side, surface or face 48B is identical with regard to both spacing and arrangement of the friction material to the front side, surface or face 48A. On the front face 48A of the friction plate 40 resides a continuous first or outer band or annulus of friction material 50 having an outer circumferential edge 52 disposed just inside and adjacent the minor diameter of the splines or teeth 46 on the periphery of the friction plate 40. Similarly, just inside and adjacent the inner edge 54 of the friction plate 40 resides an interrupted or discontinuous second or inner band or annulus of friction material comprising a plurality of equally circumferentially spaced apart arcuate segments or sections 56.

The width of the first band or annulus of friction material 50 is preferably approximately twice as wide as the width of the arcuate segments or sections of friction material 56. While six segments or sections 56 each extending over approximately 10° are illustrated in FIG. 3, it will be appreciated that fewer segments or sections 56 such as three, four, or five or more segments or sections 56 such as eight, ten or twelve may be utilized and fall within the scope of the present invention. Similarly, each of the segments or sections 56 may extend over an angle greater than 10°, especially if fewer than six sections or segments 56 are utilized; the engineering criteria being that the angular spaces between the segments or sections 56 are significantly greater than the angular length of the segments or sections 56. For example, and as stated, the segments or sections 56 extend over approximately 10° whereas the angular spaces between them extend over approximately 50°.

The segments or sections 56 are spaced radially inwardly from the first continuous band or annulus of friction material 50. Preferably, the width of the radial spaces 58 between the band or annulus 50 of friction material and the segments or sections 56 of friction material is approximately as wide as the width of the segments or sections 56. As noted above, the width, and inner and outer diameters of the first continuous band 50 of friction material and the number, width, inner and outer diameters and placement of the discontinuous segments or sections 56 are the same on each face 48A and 48B so that axial forces applied to the friction material 50 and 56 do not distort, i.e., warp, the friction plate 40.

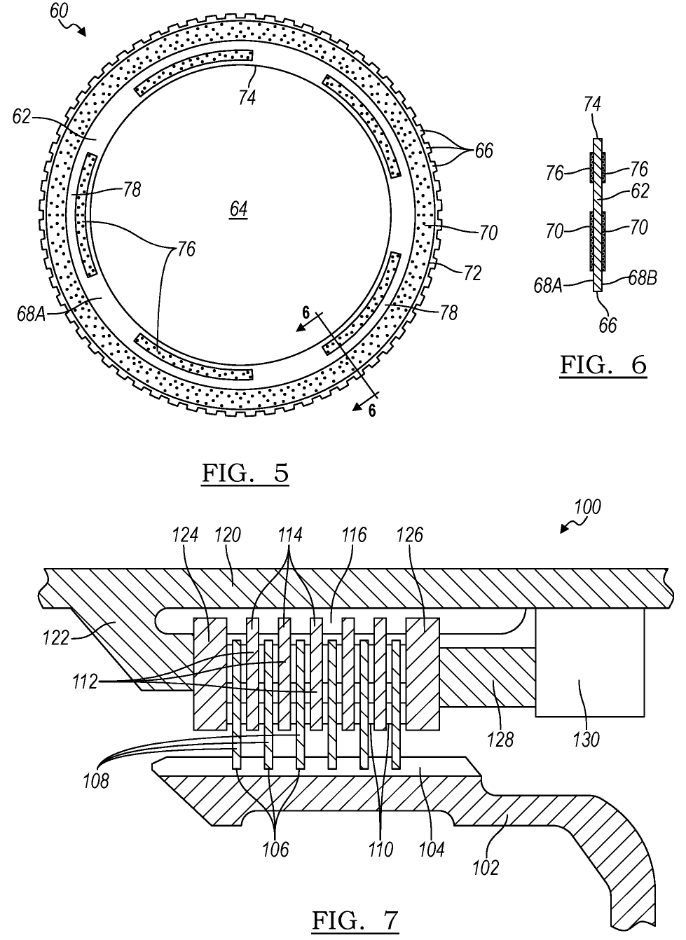

Referring now to FIGS. 5 and 6, a third embodiment of a friction clutch plate incorporating the present invention is illustrated and generally designated by the reference number 60. Once again, the third embodiment friction clutch plate 60 includes a flat or planar metal disc 62 which defines a large center opening 64 and a plurality of male splines or teeth 66 disposed and evenly circumferentially spaced about its periphery. The plurality of male splines or teeth 66 engage and drive (or are driven by) complementarily configured female spines or teeth in a clutch housing described below with reference to FIG. 7. The friction clutch plate also defines planar opposed front and back sides, faces or surfaces 68A and 68B.

An identical pattern or arrangement of friction material is disposed on both front and back surfaces 68A and 68B and thus only the complete front surface 68A is illustrated and will be described, it being understood that the back side, surface or face 68B is identical with regard to both spacing and arrangement of the friction material to the front side, surface or face 68A. On the front face 68A of the friction plate 60 resides a continuous first or outer band or annulus of friction material 70 having an outer circumferential edge 72 disposed just inside and adjacent the minor diameter of the splines or teeth 66 on the periphery of the friction plate 70. Similarly, just inside and adjacent the inner edge 74 of the friction plate 70 resides an interrupted or discontinuous second or inner band or annulus of friction material comprising a plurality of equally circumferentially spaced apart arcuate segments or sections 76.

The width of the first band or annulus of friction material 70 is preferably approximately twice as wide as the radial width of the arcuate segments or sections 76 of friction material. While five segments or sections 76 each extending over approximately 40° are illustrated in FIG. 5, it will be appreciated that fewer segments or sections 76 such as three or four, or more segments or sections 76 such as six, eight or ten may be utilized and fall within the scope of the present invention. Similarly, each of the segments or sections 76 may extend over a greater angle than 40°, especially if a smaller number than five sections or segments 76 are utilized; the engineering criteria being that the angular spaces between the segments are smaller than the angular length of the segments or sections 76. For example, and as stated, the segments or sections 76 extend over approximately 40° whereas the angular spaces between them extend over approximately 30°.

The segments or sections 76 are spaced radially inwardly from the first continuous band or annulus of friction material 70. Preferably, the width of annular spaces 78 between the continuous band or annulus of friction material 70 and the segments or sections 76 of friction material is at least as wide as the width of the segments or sections 76. As noted above, the width and inner and outer diameters of the continuous band 70 and the number, width, inner and outer diameters and placement of the discontinuous segments or sections 76 are the same on each face 68A and 68B of the friction plate 60 so that axial forces applied to the friction material 70 and segments or sections 76 of friction material do not distort, i.e., warp, the friction plate 70.

Referring now to FIG. 7, it should be understood that a friction clutch pack assembly may include either friction plates 20, 40 and 60, as illustrated and described above, having external or male splines or teeth 16, 46 and 66 which couple them to a clutch housing interleaved with reaction plates having internal or female splines or teeth which couple them to a clutch hub, or vice versa, that is, friction plates having internal splines or teeth which couple them to a hub interleaved with reaction plates having external splines or teeth which couple them to a housing. It should be understood that both friction clutch plate configurations are within the scope of the present invention.

A typical and exemplary friction pack clutch assembly having the latter configuration and incorporating the present invention is illustrated and generally designated by the reference number 100. The friction pack clutch assembly 100 includes an input hub 102 which is connected to and driven by a source of torque such as a shaft, quill, or clutch or brake component of a transmission, transfer case, differential of other torque carrying member of, for example, a motor vehicle powertrain (not illustrated). The input hub 102 includes axially extending male splines or teeth 104 which are complementary to and engage female splines or teeth 106 on a plurality of first or friction plates 108. The plurality of first or friction plates 108 each includes friction material 110 disposed on both faces which may be arranged according to any of the three embodiments of the present invention 20, 40 and 60 described directly above. The plurality of first or friction plates 108 are interleaved with a plurality of second or reaction plates 112. The reaction plates 112 are preferably fabricated of steel or aluminum and include a plurality of male splines or teeth 114 disposed about their peripheries which engage and drive complementarily configured axially extending female splines or teeth 116 on a clutch housing 120.

The clutch housing 120 may be either rotatable or stationary. On a first end of the interleaved friction clutch plates 108 and reaction plates 112, the clutch housing 120 includes an inwardly extending circular web or stop 122 and an adjacent annular backing plate 124 against which the interleaved plates 108 and 112 are compressed. On a second or opposite end of the interleaved plates 108 and 112 is an apply plate 126 which is acted upon by a piston 128 of a hydraulic, electric or pneumatic operator or actuator 130. Axial force from the operator or actuator 130 is applied across the apply plate 126, compressing the interleaved plates 108 and 112 against the backing plate 124 thereby transmitting torque through the friction pack clutch assembly 100.

Although the term “input hub” has been utilized above and the description, for reasons of clarity and simplicity, has assumed that when the clutch is engaged, torque is transmitted from the input hub 102 to the clutch housing 120, it should be appreciated that (a) not only torque may be as readily transmitted from the housing 120 of the friction pack clutch assembly 100 to the hub 102 (b) but also the assembly 100 may readily function as a brake when, as noted above, the clutch housing 120 is stationary.

It will be appreciated that friction clutch plates 20, 40 and 60 according to the present invention provide improved lubrication flow from the inner diameter of the clutch plates to their outer diameter by virtue of the radial and circumferential spacing of the bands and segments of friction material on the faces or surfaces of the plates. By providing improved lubrication flow, first of all, heat dissipation is improved and, second of all, the repeatability and proportionality of clutch engaging force versus torque transfer and thus the control of delivered torque is also improved.

The description of the invention is merely exemplary in nature and variations that do not depart from the gist of the invention are intended to be within the scope of the invention. Such variations are not to be regarded as a departure from the spirit and scope of the invention.

What is claimed is:

1. A friction plate for a friction clutch assembly comprising, in combination,
a flat, circular plate having a first face, a second face, a center opening and a plurality of splines disposed about an edge,
friction material disposed on said first face and said second face, said friction material defining a first, outer continuous band and a second, inner band radially spaced from said outer band,
Therein said inner and outer bands of friction material on said first face have inner and outer diameters the same as inner and outer diameters of said inner and outer bands of friction material on said second face.

2. The friction clutch plate of claim 1 wherein said circular plate is fabricated of metal.

3. The friction clutch plate of claim 1 wherein a width of said outer band of friction material is wider than said inner band of friction material.

4. The friction clutch plate of claim 1 wherein said outer band of friction material is radially spaced from said inner band of friction material by a distance substantially equal to a width of said inner band of friction material.

5. The friction clutch plate of claim 1 wherein said inner band of friction material is discontinuous and defines arcuate segments having a length less than a spacing between adjacent segments.

6. The friction clutch plate of claim 1 wherein said inner band of friction material is discontinuous and defines arcuate segments having a length greater than a spacing between adjacent said segments.

7. The friction clutch plate of claim 1 wherein an outer edge of said outer band of friction material is disposed adjacent said splines on an outer edge of said friction plate and an inner edge of said inner band of friction material is disposed adjacent an inner edge of said friction plate.

8. A friction plate for a friction clutch assembly comprising, in combination,
a circular metal plate having a first side, a second side, a center opening and a plurality of splines disposed about one of an inner and outer edge,
a first, outer band of friction material and a second, inner band of friction material disposed on said first side, said first, outer band of friction material radially spaced from said second, inner band of friction material,
a first, outer band of friction material and a second, inner band of friction material disposed on said second side, said first, outer band of friction material radially spaced from said second, inner band of friction material,
wherein an inner diameter and an outer diameter of said first, outer band of friction material and an inner diameter and an outer diameter of said second, inner band of friction material on said first side of said circular plate are the same as an inner diameter and an outer diameter of said first, outer band of friction material and an inner diameter and an outer diameter of said second, inner band of friction material on said second side of said circular plate.

9. The friction clutch plate of claim 8 wherein a width of said first, outer band of friction material is wider than said second, inner band of friction material.

10. The friction clutch plate of claim 8 wherein said outer band of friction material is radially spaced from said inner band of friction material by a distance substantially equal to a width of said inner band of friction material.

11. The friction clutch plate of claim 8 wherein said second, inner band of friction material is discontinuous and defines arcuate segments having lengths less than a spacing between adjacent said segments.

12. The friction clutch plate of claim 8 wherein said second, inner band of friction material is discontinuous and defines arcuate segments having lengths greater than a spacing between adjacent said segments.

13. The friction clutch plate of claim 8 wherein an outer edge of said first, outer band of friction material is disposed adjacent said outer edge of said friction plate and an inner edge of said second, inner band of friction material is disposed adjacent said inner edge of said friction plate.

14. A friction clutch assembly comprising, in combination,
a hub having axially extending male splines,
a plurality of first plates having female splines engaging said male splines on said hub,
a plurality of second plates interleaved with said first plates and having male splines,
a clutch housing having female splines engaged by said male splines on said second plurality of plates,
a clutch operator for applying pressure to said interleaved first and second pluralities of plates,
one of said plurality of plates having friction material disposed on both faces of each of said plurality of plates, said friction material defining a first, outer continuous band and a second, inner band radially spaced from said outer band,
wherein said inner and outer bands of friction material on said both faces of each clutch plate have the same inner and outer diameters.

15. The friction clutch assembly of claim 14 wherein said one of said plurality of plates having friction material disposed on both faces are friction plates and said other plurality of plates are reaction plates.

16. The friction clutch assembly of claim 14 wherein a width of said outer band of friction material is wider than said inner band of friction material.

17. The friction clutch plate of claim 14 wherein said first, outer band of friction material is radially spaced from said second, inner band of friction material by a distance substantially equal to a width of said inner band of friction material.

18. The friction clutch plate of claim 14 wherein said second, inner band of friction material is discontinuous and defines arcuate segments having a length less than a spacing between adjacent said segments.

19. The friction clutch plate of claim 14 wherein said second, inner band of friction material is discontinuous and defines arcuate segments having lengths greater than a spacing between adjacent said segments.
